(19) United States
(12) Patent Application Publication
(10) Pub. No.: US 2024/0346365 A1
(43) Pub. Date: Oct. 17, 2024

(54) SYSTEMS AND METHODS FOR DEPLOYING ARTIFICIAL INTELLIGENCE/MACHINE LEARNING MODELS AS CLOUD-NATIVE WEB SERVICES

(71) Applicant: JPMORGAN CHASE BANK, N.A., New York, NY (US)

(72) Inventors: Florenz Allewijn Pieter HOLLEBRANDSE, Glasgow (GB); Mark SINTON, New York, NY (US)

(21) Appl. No.: 18/299,589

(22) Filed: Apr. 12, 2023

(51) Int. Cl. G06N 20/00

(52) U.S. Cl. CPC G06N 20/00

(57) ABSTRACT

Systems and methods for deploying artificial intelligence/machine learning models as cloud-native web services are disclosed. A method may include: (1) starting, by an integration layer on a cloud platform, a webserver accepting requests; (2) scanning, by the integration layer, an application environment for a model loading function for an artificial intelligence/machine learning (AI/ML) model and a model invocation function for the AI/ML model; (3) configuring, by the integration layer, the webserver based on information from an AI/ML service; (4) executing, by the integration layer, the model loading function to load a model object; (5) accepting, by the integration layer and the webserver, an incoming AI/ML model invocation request from a client; (6) executing, by the integration layer, the model invocation function with data by causing the AI/ML service to execute the AI/ML model; and (7) returning, by the integration layer, an output of the AI/ML model to the client.

### BACKGROUND OF THE INVENTION

### 1. Field of the Invention

Embodiments relate generally to systems and methods for deploying artificial intelligence/machine learning models as cloud-native web services.

### 2. Description of the Related Art

The development of applications incorporating Artificial Intelligence (AI) or Machine Learning (ML) models typically follows a number of distinct phases. The early stages include the development, training and evaluation of an AI/ML algorithm. This is typically referred to as the “training phase.” Later stages of the development process include the integration of the AI/ML algorithm or model in a software application to allow the model to be invoked. In this stage, the AI/ML model operates in “inference” or “serving” mode in contrast to a “training” mode during the earlier phases.

Many AI/ML analytical software frameworks (e.g., TensorFlow, Torch, MXNet, Scikit-Learn) allow previously trained models to be invoked using a few lines of code only. For robust integrations with a wider application suite, however, more advanced systems and frameworks are required. In real-life (e.g., “production”) application environments such systems provide essential quality assurance and monitoring mechanisms allowing enterprises to operate highly-available AI/ML applications.

Large Information Technology (IT) providers' offerings include streamlined services for both training and serving of AI/ML models as part of their wider IT “cloud” services. For example, Amazon Web Services (AWS) offers a service named “SageMaker” which includes high-level components to run AI/ML model without customers requiring to manage network and compute infrastructure. Deploying a model for inference with an AI/ML service requires software engineers to write certain logic and configuration suitable for the chosen service. In addition to generic technology such as application containers, some cloud service providers require engineers to adopt vendor-specific libraries or Software Development Kits (SDKs) to complete a full integration of the AI/ML model.

### SUMMARY OF THE INVENTION

Systems and methods for deploying artificial intelligence/machine learning models as cloud-native web services are disclosed. In one embodiment, a method for deploying artificial intelligence/machine learning models as cloud-native web services may include: (1) starting, by an integration layer on a cloud platform, a webserver accepting requests; (2) scanning, by the integration layer, an application environment for a model loading function for an artificial intelligence/machine learning (AI/ML) model and a model invocation function for the AI/ML model; (3) configuring, by the integration layer, the webserver based on information from an AI/ML service; (4) executing, by the integration layer, the model loading function to load a model object; (5) accepting, by the integration layer and the webserver, an incoming AI/ML model invocation request from a client; (6) executing, by the integration layer, the model invocation function with data by causing the AI/ML service to execute the AI/ML model; and (7) returning, by the integration layer, an output of the AI/ML model to the client.

In one embodiment, the webserver may be an HTTP webserver.

In one embodiment, the integration layer may configure the webserver by specifying a number of invocations to handle concurrently and/or a number of central processing units available.

In one embodiment, incoming AI/ML model invocation request may be received at a http address.

In one embodiment, the method may further include transforming, by the integration layer, a data structure from the incoming AI/ML model invocation request to a format for the AI/ML model; and transforming, by the integration layer, the output of the AI/ML model for transport to the client.

In one embodiment, executing the model invocation function may pass the data and the model object to AI/ML service.

In one embodiment, the method may further include receiving, by the integration layer and from the AI/ML service, a health status.

According to another embodiment, a system may include: a cloud platform; an artificial intelligence/machine learning (AI/ML) service deployed in the cloud platform; an application environment deployed in the AI/ML service; an integration layer and a AI/ML model deployed in the application environment; and a client electronic device executing a client computer program. The integration layer starts a webserver accepting requests, scans the application environment for a model loading function for the AI/ML model and a model invocation function for the AI/ML model, configures the webserver based on information from an AI/ML service, executes the model loading function to load a model object, accepts, using the webserver, an incoming AI/ML model invocation request from a client, executes the model invocation function with data by causing the AI/ML service to execute the AI/ML model, and returns an output of the AI/ML model to the client.

In one embodiment, the webserver may be an HTTP webserver.

In one embodiment, the integration layer may configure the webserver by specifying a number of invocations to handle concurrently and/or a number of central processing units available.

In one embodiment, the incoming AI/ML model invocation request may be received at a http address.

In one embodiment, the integration layer may transforms a data structure from the incoming AI/ML model invocation request to a format for the AI/ML model, and transforms the output of the AI/ML model for transport to the client.

In one embodiment, executing the model invocation function may pass the data and the model object to AI/ML service.

In one embodiment, the integration layer may receive, from the AI/ML service, a health status.

According to another embodiment, a non-transitory computer readable storage medium may include instructions stored thereon, which when read and executed by one or more computer processors, cause the one or more computer processors to perform steps including: starting a webserver accepting requests; scanning an application environment for a model loading function for an artificial intelligence/machine learning (AI/ML) model and a model invocation function for the AI/ML model; configuring the webserver based on information from an AI/ML service; executing the model loading function to load a model object; accepting an incoming AI/ML model invocation request from a client; executing the model invocation function with data by causing the AI/ML service to execute the AI/ML model; and returning an output of the AI/ML model to the client.

In one embodiment, the webserver may bean HTTP webserver.

In one embodiment, the webserver may be configured by specifying a number of invocations to handle concurrently and/or a number of central processing units available.

In one embodiment, the incoming AI/ML model invocation request may be received at a http address.

In one embodiment, the non-transitory computer readable storage medium may also include instructions stored thereon, which when read and executed by one or more computer processors, cause the one or more computer processors to perform steps comprising: transforming a data structure from the incoming AI/ML model invocation request to a format for the AI/ML model; and transforming the output of the AI/ML model for transport to the client.

In one embodiment, the non-transitory computer readable storage medium may also include instructions stored thereon, which when read and executed by one or more computer processors, cause the one or more computer processors to perform steps comprising: receiving a health status.

### BRIEF DESCRIPTION OF THE DRAWINGS

FIG. 1 depicts a system for deploying artificial intelligence/machine learning models as cloud-native web services according to an embodiment;

FIG. 2 depicts a method for deploying artificial intelligence/machine learning models as cloud-native web services according to an embodiment.

FIG. 3 depicts an exemplary computing system for implementing aspects of the present disclosure.

### DETAILED DESCRIPTION OF PREFERRED EMBODIMENTS

Embodiments relate generally to systems and methods for deploying artificial intelligence/machine learning models as cloud-native web services.

To simply the integration of AL and ML models into cloud platforms, embodiments disclosed herein provide a modular framework to integrate the AI/ML models with a cloud service as a web service, such as an HTTP web service. For example, embodiments may define two “functions” in a programming language-a model loading function and a model invocation function. These functions provide the basic integration points, or “hooks” with the framework so that the framework can load and invoke the AI/ML model to make predictions.

Embodiments may provide the following:
(1) A standard method to define how the AI/ML model should be loaded. This may include defining a model loading function as a connector in a programming language. This model loading function loads the model into a computer's working memory (RAM) for a given set of model artifacts on a specific storage location (physical hard disk, cloud storage, etc.). The model loading function may be invoked by the AI/ML service when the AI/ML model is deployed or activated.
(2) A standard method to define how the AI/ML model should be invoked. This may include defining a model invocation function as a function in a programming language. This function processes invocation requests as sent by clients and applies the input data to the AI/ML model to generate predictions. The function then returns the predictions to clients or client applications.
(3) An integration layer that executes the model invocation function each time the AI/ML service sends an inference request to the HTTP service. The integration layer provides a bridging function to a generic HTTP AI/ML inference service and AI/ML algorithms. Thus, a software engineer is not required to program or configure the integration layer except for defining the model function and the invocation function.
(4) A pluggable software architecture that uses a “dependency injection” programming pattern. This allows engineers to simply declare the two functions without requiring the invocation of these function to be programmed. An engineer may install the functions as a software package or library in the cloud environment. This injects the two functions into the integration layer.
(5) Optional plugin functions for deserializing the model inputs and serializing the model outputs. These may be used to convert the generic input data into programming language-native objects and to convert the model predictions back to generic output data. These plugin functions are optional and the integration layer may provide a default implementation that may convert to and from JSON (JavaScript Object Notation) binary data.
(6) A modular design allowing the individual plugin functions to be developed and provisioned independently. This allows the input/output serialization functions to be developed and packaged separately for re-use by different AI/ML models.
(7) A low-code or no-code development environment the model loading and invocation functions may be configured using a graphical user interface (GUI).

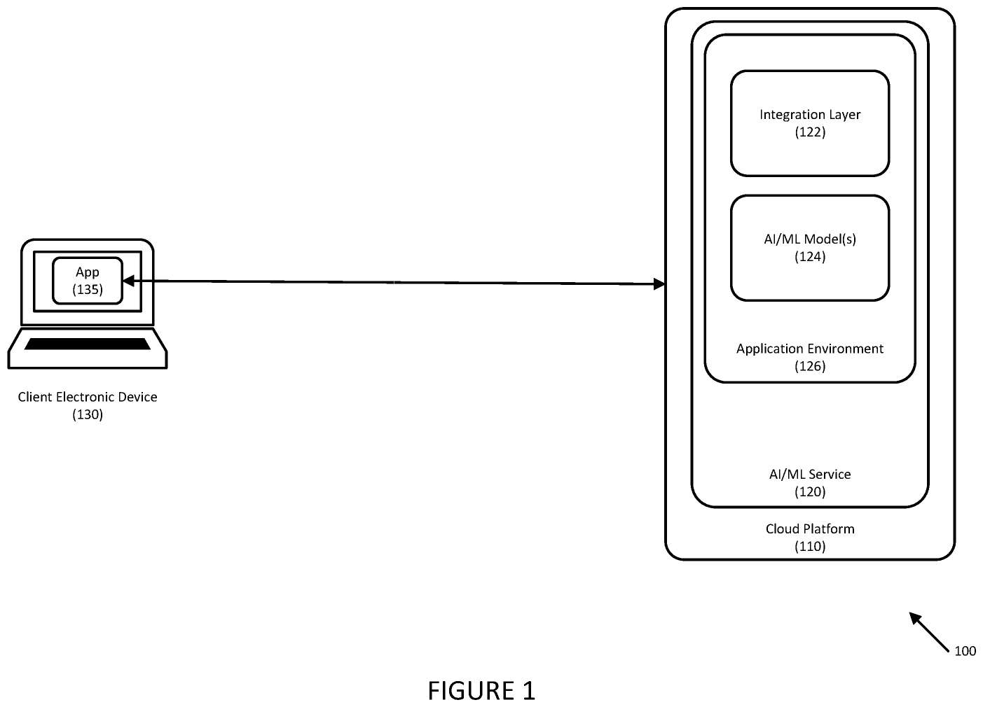

Referring to FIG. 1, a system for deploying artificial intelligence/machine learning models as cloud-native web services is disclosed according to an embodiment. System 100 may include cloud platform 110, which may be any suitable cloud platform. Cloud platform 110 may execute AI/ML service 120, which may be any suitable AI/ML service.

AI/ML service 120 may include integration layer 122 and AI/ML models 124. Integration layer 122 may interface with client application (“app”) 135 executed by client electronic device 130. Client electronic device 130 may be any suitable electronic device that may execute client app 135, including servers (e.g., physical and/or cloud-based), computers (e.g., workstations, desktops, laptops, notebooks, tablets, etc.), smart devices, Internet of Things appliances, etc. In one embodiment, client electronic device 130 or client application 135 may be part of cloud platform 110.

Client application 135 may interface with cloud platform 110, which may pass requests to AI/ML service 120. Integration layer 122 may listen for requests from AI/ML service 120.

In one embodiment, a software engineer may provide the two functions—the model loading function and the model invocation function—to integration layer 122. Integration layer 122 may use the model loading function to load one of the AI/ML models 124, and may use the model invocation function to invoke one of the AI/ML models 124.

The plugin functions may be installed along with the integration layer and the AI/ML model itself within application environment 126 in cloud platform 110. Application environment 126 may include an application container (e.g., Docker, not shown) or an alternative application packaging and deployment mechanism. Application environment 126 may then be deployed within the AI/ML service 120.

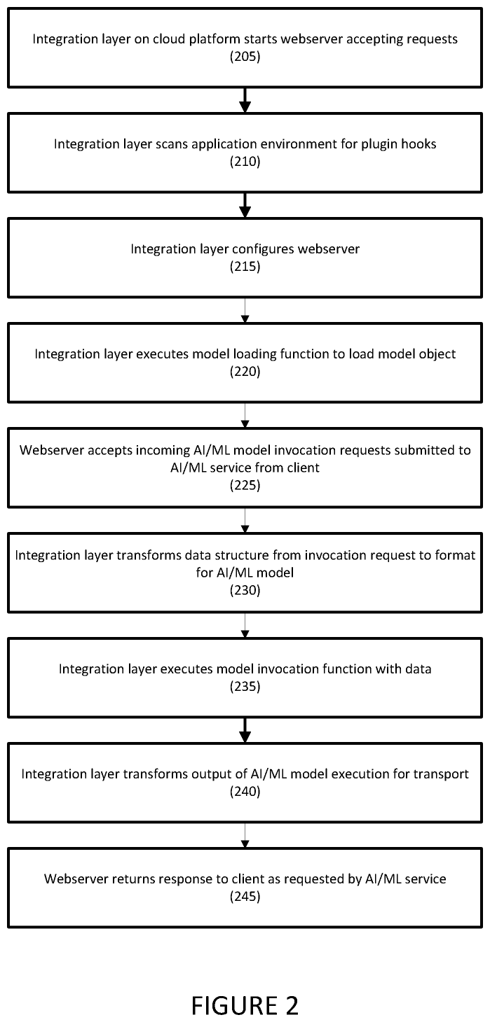

Referring to FIG. 2, a method for deploying artificial intelligence/machine learning models as cloud-native web services is disclosed according to an embodiment.

In step 205, an integration layer on a cloud platform may start a webserver accepting requests. For example, the integration layer may start an HTTP (web) server accepting client requests as per HTTP or HTTPS network protocols.

In step 210, the integration layer scans application environment for functions, such as a model loading function and the model invocation function. For example, during the webserver startup sequence, the integration layer may scan the application environment to discover any installed plugins. This may include scanning the environment for installed libraries, packages or modules and verifying whether any of these define one or more plugin functions.

In step 215, the integration layer may configure the webserver. For example, the framework may apply automatic configuration of the HTTP server, such as configuring how many invocations may be handled concurrently. In one embodiment, the automatic configuration may be based on information obtained from the AI/ML service or the AI/ML algorithm itself. For example, the integration layer may discover the capacity of the compute instance to which the application environment is deployed to in terms of total number of processors (CPUs) available and configure a corresponding maximum number of invocations that should be processed concurrently.

In step 220, the integration layer may execute a model loading function to load a model object. The model object may be retained in memory.

In step 225, the webserver accepts incoming AI/ML model invocation requests submitted to AI/ML service from a client. For example, the integration layer and webserver may accept incoming model invocation requests as sent by the AI/ML server to a container. For example, the integration layer may processes requests sent to a well-known address, as specified by the AI/ML server, for example “https://<ipaddress>/invocations/”.

In step 230, the integration layer may optionally transform a data structure from the invocation request to a format for the AI/ML model. For example, the integration layer may invoke an input deserialization plugin function. The deserialization function is provided with the raw, binary data as sent over the network. The value returned by the deserialization function is a data structure that the AI/ML model expects.

In step 235, the integration layer may execute the model invocation function with data. Once the library has received the input features, it may execute the model invocation function by passing the input data alongside the model object. This executes the actual AI/ML algorithm and return a prediction for the given input features.

In step 240, the integration layer may optionally transform the output of AI/ML model execution for transport. For example, the integration layer may invoke the output serialization plugin hook and with the prediction data structure as provided by the AI/ML model. The value returned by the serialization function may be raw, binary data suitable for HTTP network transport.

In step 245, the webserver may return a response to client as requested by AI/ML service. For example, the integration layer may provide the binary output data to the webserver along with relevant standard meta data such as the serialization form (e.g. JSON). The webserver may return the response to the client as requested by the AI/ML service.

In addition, the integration layer may automatically respond to “health status” requests that may be periodically sent by the AI/ML service to check whether the AI/ML model is available to accept invocation requests and return predictions. The integration layer may respond affirmative to such requests as long as the model object is loaded and available in memory.

If the health status indicates that the AI/ML model is unavailable, the AI/ML service may attempt to restart the application environment, issues alerts to application operators, etc.

Optionally, the integration layer may discover any custom health check plugin hooks. This will allow engineers to develop comprehensive health checks, for example, for custom AI/ML algorithms that rely on external data sources, services etc.

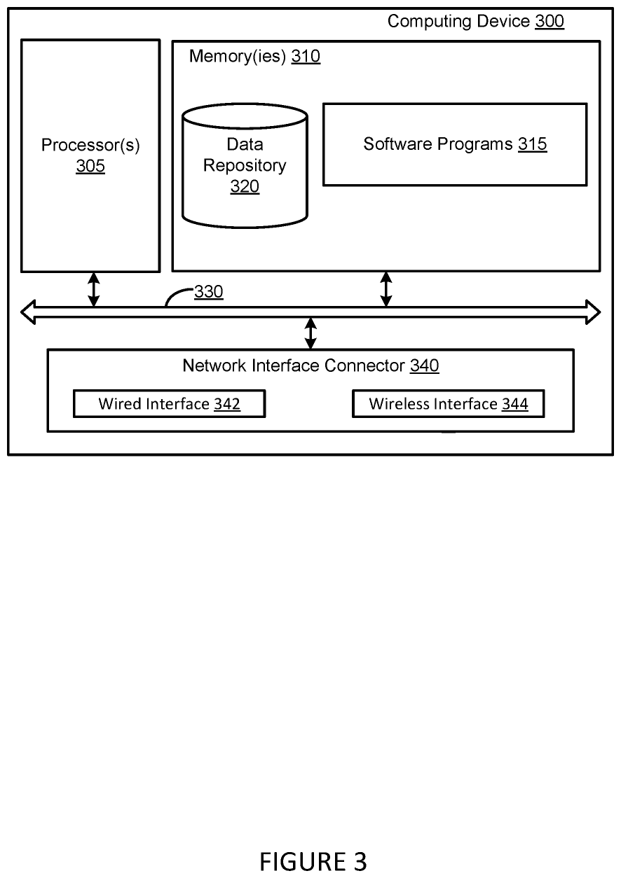

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Additional details are provided in the attached Appendix, the disclosure of which is hereby incorporated, by reference, in its entirety.

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for deploying artificial intelligence/machine learning models as cloud-native web services, comprising:
starting, by an integration layer on a cloud platform, a webserver accepting requests;
scanning, by the integration layer, an application environment for a model loading function for an artificial intelligence/machine learning (AI/ML) model and a model invocation function for the AI/ML model;
configuring, by the integration layer, the webserver based on information from an AI/ML service;
executing, by the integration layer, the model loading function to load a model object;
accepting, by the integration layer and the webserver, an incoming AI/ML model invocation request from a client;
executing, by the integration layer, the model invocation function with data by causing the AI/ML service to execute the AI/ML model; and
returning, by the integration layer, an output of the AI/ML model to the client.

2. The method of claim 1, wherein the webserver is an HTTP webserver.

3. The method of claim 1, wherein the integration layer configures the webserver by specifying a number of invocations to handle concurrently and/or a number of central processing units available.

4. The method of claim 1, wherein the incoming AI/ML model invocation request is received at a http address.

5. The method of claim 1, further comprising:
transforming, by the integration layer, a data structure from the incoming AI/ML model invocation request to a format for the AI/ML model; and
transforming, by the integration layer, the output of the AI/ML model for transport to the client.

6. The method of claim 1, wherein executing the model invocation function passes the data and the model object to AI/ML service.

7. The method of claim 1, further comprising:
receiving, by the integration layer and from the AI/ML service, a health status.

8. A system, comprising:
a cloud platform;
an artificial intelligence/machine learning (AI/ML) service deployed in the cloud platform;
an application environment deployed in the AI/ML service;
an integration layer and a AI/ML model deployed in the application environment; and
a client electronic device executing a client computer program;
wherein the integration layer starts a webserver accepting requests, scans the application environment for a model loading function for the AI/ML model and a model invocation function for the AI/ML model, configures the webserver based on information from an AI/ML service, executes the model loading function to load a model object, accepts, using the webserver, an incoming AI/ML model invocation request from a client, executes the model invocation function with data by causing the AI/ML service to execute the AI/ML model, and returns an output of the AI/ML model to the client.

9. The system of claim 8, wherein the webserver is an HTTP webserver.

10. The system of claim 8, wherein the integration layer configures the webserver by specifying a number of invocations to handle concurrently and/or a number of central processing units available.

11. The system of claim 8, wherein the incoming AI/ML model invocation request is received at a http address.

12. The system of claim 8, wherein the integration layer transforms a data structure from the incoming AI/ML model invocation request to a format for the AI/ML model, and transforms the output of the AI/ML model for transport to the client.

13. The system of claim 8, wherein executing the model invocation function passes the data and the model object to AI/ML service.

14. The system of claim 8, wherein the integration layer receives, from the AI/ML service, a health status.

15. A non-transitory computer readable storage medium, including instructions stored thereon, which when read and executed by one or more computer processors, cause the one or more computer processors to perform steps comprising:
starting a webserver accepting requests;
scanning an application environment for a model loading function for an artificial intelligence/machine learning (AI/ML) model and a model invocation function for the AI/ML model;
configuring the webserver based on information from an AI/ML service;
executing the model loading function to load a model object;
accepting an incoming AI/ML model invocation request from a client;
executing the model invocation function with data by causing the AI/ML service to execute the AI/ML model; and
returning an output of the AI/ML model to the client.

16. The non-transitory computer readable storage medium of claim 15, wherein the webserver is an HTTP webserver.

17. The non-transitory computer readable storage medium of claim 15, wherein the webserver is configured by specifying a number of invocations to handle concurrently and/or a number of central processing units available.

18. The non-transitory computer readable storage medium of claim 15, wherein the incoming AI/ML model invocation request is received at a http address.

19. The non-transitory computer readable storage medium of claim 15, further comprising instructions stored thereon, which when read and executed by one or more computer processors, cause the one or more computer processors to perform steps comprising:
transforming a data structure from the incoming AI/ML model invocation request to a format for the AI/ML model; and
transforming the output of the AI/ML model for transport to the client.

20. The non-transitory computer readable storage medium of claim 15, further comprising instructions stored thereon, which when read and executed by one or more computer processors, cause the one or more computer processors to perform steps comprising:
receiving a health status.
